(19) United States
(12) Patent Application Publication
(10) Pub. No.: US 2016/0062656 A1
(43) Pub. Date: Mar. 3, 2016

(54) Command Set Extension for Non-Volatile Memory

(71) Applicants: Ravindraraj Ramaraju, Round Rock, TX (US); George P. Hoekstra, Austin, TX (US)

(72) Inventors: Ravindraraj Ramaraju, Round Rock, TX (US); George P. Hoekstra, Austin, TX (US)

(73) Assignee: FREESCALE SEMICONDUCTOR, INC., Austin, TX (US)

(21) Appl. No.: 14/471,871

(22) Filed: Aug. 28, 2014

(51) Int. Cl. G06F 3/06

(52) U.S. Cl. CPC G06F 3/0604; G06F 3/0659; G06F 3/0679

(57) ABSTRACT

A method and apparatus are provided for generating an adjusted internal electrical parameter for accessing a NAND Flash memory array based on an adjustment control parameter conveyed by a memory access instruction, where the memory access instruction is compliant with an Open NAND Flash Interface (ONFI) protocol to include a two command cycle sequence to specify a command for accessing the NAND Flash memory with the adjusted internal electrical parameter.

### BACKGROUND OF THE INVENTION

1. Field of the Invention

The present invention is directed in general to non-volatile memory devices and methods for operating same. In one aspect, the present invention relates to flash memory systems and devices and associated methods for operation for adjusting internal electrical values during operation thereof.

2. Description of the Related Art

In electronic devices, non-volatile memory (NVM) or storage devices are used to store information or data. Examples of non-volatile memory include read-only memories, NOR and NAND flash memories, single data rate synchronous dynamic random access memories (SDR-SDRAM), double-data rate synchronous dynamic random access memories (DDR-SDRAMs), and hard disk drives (HDDs). To provide additional data storage density, multi-level cell (MLC) memory elements have been developed which are capable of storing more than a single bit of information in each cell. For example, MLC NAND flash memory uses multiple levels per cell to allow more bits to be stored using the same number of transistors. In contrast to single-level cell (SLC) NAND flash technology where each cell can exist in one of two states to store one bit of information per cell, MLC NAND flash memory has four possible states per cell, so it can store two bits of information per cell. However, there are significant challenges for discerning between the multi-level values stored in a single cell due to the reduced amount of margin separating the states, and these challenges are exacerbated by decreasing geometry sizes, reduced operating voltages, and changes in electrical performance due to environmental conditions (e.g., temperature changes) and performance-related degradation (e.g., extensive program/erase cycles in a flash memory). As a result, the existing solutions for correctly storing and detecting non-volatile memory data are extremely difficult at a practical level.

### BRIEF DESCRIPTION OF THE DRAWINGS

The present invention may be understood, and its numerous objects, features and advantages obtained, when the following detailed description is considered in conjunction with the following drawings.

FIG. 1 illustrates a simplified block diagram of a flash memory device in accordance with selected embodiments of the present disclosure.

FIG. 2 illustrates a simplified circuit schematic of a plurality of MLC NAND strings in accordance with selected embodiments of the present disclosure.

FIG. 3 illustrates a threshold voltage (Vt) distribution graph for a multi-level flash memory cell in which one or more reference voltages may be adjusted in accordance with selected embodiments of the present disclosure.

FIG. 4 illustrates a simplified flow chart of a method for reading a multi-level flash memory cell using one or more adjustable reference voltages in accordance with selected embodiments of the present disclosure.

FIG. 5 illustrates a simplified flow chart of a method for adjusting one or more internal electrical values used in the operation of a non-volatile memory device in accordance with selected embodiments of the present disclosure.

FIG. 6 illustrates an example embodiment of a command set extension for use in controlling the operation of a NAND Flash device to adjust one or more reference voltages in accordance with selected embodiments of the present disclosure.

### DETAILED DESCRIPTION

An integrated circuit memory device and associated method of operation are described for using control codes to adjust one or more internal electrical parameters when accessing the integrated circuit memory device to address various problems in the art where various limitations and disadvantages of conventional solutions and technologies will become apparent to one of skill in the art after reviewing the remainder of the present application with reference to the drawings and detailed description provided herein. In selected embodiments, the operation of a non-volatile or flash memory device may be controlled through one or more command set extensions to the Open NAND Flash Interface (ONFI) command set which provide as defined adjustment to one or more internal electrical parameters (e.g., an internal reference voltage or detection point) used when accessing the non-volatile or flash memory device. For example, a host processor can communicate information (e.g., control commands, addresses, data) to an NVM device over a standardised NAND Flash device interface (such as is described in ONFI specification version 3.0) in which command set extensions are defined for adjusting one or more internal reference voltage values used to read, program and/or erase the voltage state stored in a multi-level cell of an accessed NAND string in the NVM device. With a first command set extension instruction, a charge pump device, which supplies one or more read voltages to the word line gates of a set of NVM cells, may be instructed to increase the read voltage(s) by a predetermined increment or value (e.g., +10 mV), thereby effectively increasing one or more internal reference voltages or detection points by the predetermined increment or value. With a second command set extension instruction, the charge pump device may be instructed to decrease the read voltage(s) by a predetermined increment or value (e.g., −10 mV), thereby effectively decreasing one or more internal reference voltages or detection points by the predetermined increment or value. With a third command set extension instruction, the charge pump device may be instructed to generate default or nominal read voltage(s) which are not adjusted, while a fourth command set extension instruction may instruct the charge pump device to generate default or nominal read voltage(s) which include a temperature compensation adjustment.

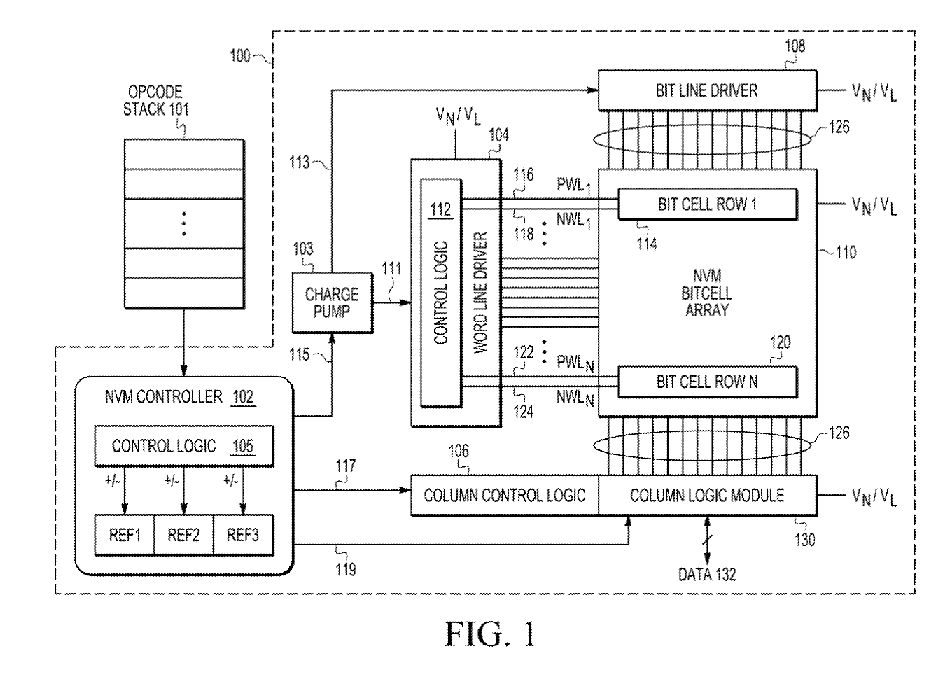

Turning now to FIG. 1, there is shown a simplified block diagram of a flash memory device 100 in accordance with selected embodiments of the present disclosure. The flash memory device 100 includes a non-volatile memory bitcell array 110 which contains one or more strings or blocks of bit cells, an NVM controller 102, a charge pump circuit 103, a word line driver 104, a bit line driver 108, and a column logic module 130 with associated column control logic 106. Though not shown, it will be appreciated that the flash memory device 100 may be connected to one or more processors and additional memory (e.g., volatile memory) and/or external input-output (I/O) devices or other devices over a common bus or via separate connections, in this way, the flash memory device 100 is connected to receive one or more instructions or commands 101 (e.g., from an opcode stack) to control the operation of the flash memory device 100.

The NVM bitcell array 110 may be embodied with an array of multi-level NVM bit cells organized in rows and columns and organized as a plurality of sectors or strings (e.g., bitcell rows 114, 120). According to selected embodiments, the NVM bit cell array 110 includes a plurality of erase blocks, wherein the bits of an individual erase block are erased simultaneously. The NVM array 110 can include any of a variety of non-volatile memory architectures, such as, for example, a thin-film storage (TFS) architecture, high-k dielectric or nanocrystal architectures, nitride-based architectures, resistive memory-based architectures, magnetic random access memory (MRAM) architectures, and the like. In the illustrated embodiment, access to a particular NVM bit cell row is initiated based on the manipulation of a corresponding pair of word lines, identified herein as PWL and NWL, whereby each word line of the pair can be independently configured by control logic 112 of the word line driver 104. For example, a first NVM bit cell row 114 may be accessed based on a pair of word lines comprising PWL₁ 116 and NWL₁ 118 and an Nth NVM bit cell row 120 is accessed based on a pair of word lines comprising PWL_{N} 122 and NWL_{N} 124. In other embodiments, each NVM bitcell row is accessed with a single corresponding wordline (e.g., WL0-WLN). The bit cells of an accessed VIM bit cell row are modified during write accesses based on the configuration of the bit lines 126 by the bit line driver 108 in response to write data. Likewise, the bit cells of an accessed NVM bit cell row are selectively accessed for read accesses based on the configuration of word lines (e.g., 116, 11 by the word hue driver 104 and the configuration of the bit lines 126 by the column logic module 130.

The NVM controller 102 includes control logic 105 which may be implemented with a finite state machine (FSM), a microprocessor with executable code (e.g., firmware), and the like. The NVM controller 102 is connected to the NVM bit cell array 110 across one or more signal lines 117, 119 to control operations on the bit cell array, such as reading, writing, and erasing of bits within the bit cell array 110. The NVM controller 102 is also connected across a signal line 115 to control operation of the charge pump 103 which generates the bias levels for program, erase, and read operations, such as by adjusting the voltage levels used to determine stored voltage levels in each NVM bitcell.

The charge pump circuit 103 is controlled by control signal provided by the NVM controller 102 at the signal line 115 to provide bias voltages 111, 113 to the word line driver 104 and/or bit line driver 108 for accessing the NVM bit cell array lit) during program, erase, and read operations. For example, the charge pump circuit 103 may be controlled to provide a plurality of increasing read reference voltages 111 that are applied to the gate of an MLC bitcell during a read operation, where at least one of the read reference bias voltages 111 is increased or decreased from a nominal or default read reference voltage value for from previously stored read reference bias voltage value(s)) in response to the control signal provided by the NVM controller 102 at the signal line 115. In other embodiments, the charge pump circuit 103 may be controlled to provide a plurality of write reference voltages 113 that are supplied to the bit line driver 108 during a write operation, where at least one of the write reference bias voltages 113 is increased or decreased from a nominal or default write reference voltage value (or from previously stored write reference bias voltage value(s)) in response to the control signal provided by the NVM controller 102 at the signal line 115.

The word line driver 104, bit line driver 108, column logic module 130, and column control logic 106 are operable to selectively access one or more NVM bitcells in the array 110 during program, erase, and read operations using any desired circuitry and/or control logic to implement the access functionality. In addition, the flash memory device 100 may include additional circuitry and logic for implementing the functions of the depicted circuit blocks, including logic circuitry for controlling various functions of the driver circuits, registers for storing address and data, circuitry for generating the required program and erase voltages, and core memory circuits for the NVM bit cell array 110. As such functions of the depicted circuit blocks in the flash memory device 100 are well known in the art, additional details are not provided, and it will be appreciated by persons skilled in the art that other flash memory configurations can be used.

In operation, the NVM controller 102 controls the read, program, and erase operations of the flash memory device 100 in response to commands or instructions 101 received from a host or control processor (not shown). As disclosed herein, the received commands or instructions may be processed as an opcode stack 101 of ONFI commands which include predetermined commands or command set, extensions which enable the user to specify a defined adjustment to one or more internal electrical parameters (e.g., an internal reference voltage or detection point) used when accessing the flash memory device 100 during read, program and/or erase operations. With a first defined ONFI command set or opcode instruction is decoded by the NVM controller 102, the control logic 105 uses a nominal or default set of reference voltage parameter values (e.g., REF1, REF2, REF3) which are adjusted to account for temperature compensation and then conveyed over signal line 115 to control the charge pump circuit 103 to supply correspondingly bias voltages to the word line gates of a selected row of MLC NVM cells (e.g., 114) during access thereof. However, when a second defined ONFI command set or opcode instruction is decoded by the NVM controller 102, the control logic 105 increments or increases one or more of the reference voltage parameter values (e.g., REF1, REF2, REF3), which in turn are conveyed over signal line 115 to the charge pump circuit 103 which supplies correspondingly adjusted bias voltages to the word line gates of a row of MLC NVM cells (e.g., 114) during access thereof. And when a third defined ONFI command set or opcode instruction is decoded by the NVM controller 102, the control logic 105 is configured to decrement or decrease one or more of the reference voltage parameter values (e.g., REF1, REF2, REF3), which in turn are conveyed over signal line 115 to the charge pump circuit 103 which supplies correspondingly adjusted bias voltages to the word line gates of a row of MIX NVM cells (e.g., 114) during access thereof. Finally, a fourth defined ONFI command set or opcode instruction may be decoded by the NVM controller 102 so that control logic 105 uses the nominal or default set of reference voltage parameter values (e.g., REF1, REF2, REF3) without adjustment for temperature compensation, which in turn are conveyed over signal line 115 to the charge pump circuit 103 which supplies correspondingly unadjusted bias voltages to the word line gates of a row of MLC NVM cells (e.g., 114) during access thereof.

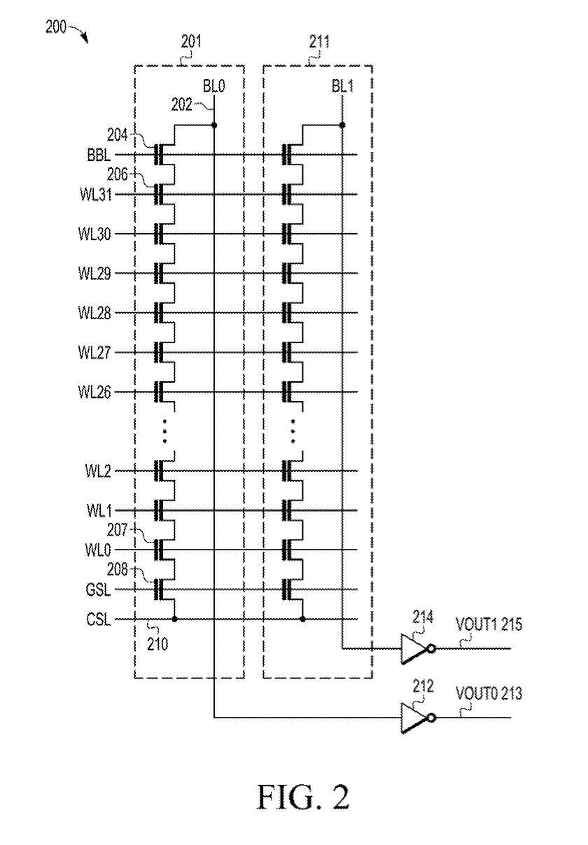

FIG. 2 illustrates a simplified circuit schematic of an NVM bitcell array 200 which is embodied with a plurality of MLC NAND strings 201, 211 in accordance with selected embodiments of the present disclosure. Each NAND memory cell string (e.g., 201) includes a plurality (e.g. 32) of serially connected floating gate memory cells (e.g., 206-207), each connected to respective word lines (e.g., WL31 to WL0); a string select transistor (e.g., 204) connected between the bitline (e.g., BL0 202) and the first floating gate memory cell (e.g., 206); and a ground select transistor (e.g., 208) connected between a common source line (CSL) 210 and the last floating gate memory cell (e.g., 207). The gate of string select transistor 204 receives a string select signal SSL, while the gate of ground select transistor 208 receives a ground select signal GSL. The NAND memory cell strings of a block share common word lines, string select SSL, and ground select GSL signal lines.

To detect and output the value stored at an accessed bitcell, each NAND memory cell string (e.g., 201, 211) has its shared bitline (e.g., BL0, BL1) connected to an associated detection inverter circuit (e.g., 212, 214) which generates a corresponding output voltage (e.g., VOUT0 213, VOUT1 215) to indicate the stored value stored in an accessed bitcell. Each detection inverter circuit (e.g., 212) may be implemented as a trip point inverter which generates a LOW or logical “0” output voltage VOUT0 until such time as the threshold voltage Vt of an accessed bitcell is reached to pull the associated bit line (e.g., BL0) below the inverter trip point, at which point the detection inverter circuit 212 generates a HIGH or logical “1” output voltage VOUT0. Alternatively, a sense amplifier circuit (not shown) may be connected to each bit line for generating an output voltage based on a comparison of the bit line voltage to a reference voltage.

As will be appreciated, the erase, program, and read operations for each NAND memory cell string are well-known techniques in the art. For example, the NAND memory cell strings 201, 211 of the memory array 110 may be erased to a first state (e.g., a logic “11”) by applying appropriate voltages to clear stored charge from the bitcell according to well-known techniques in the art, such as by applying a negative word line pulse (e.g., WL31) to the gate of the selected bitcell (e.g., 206) with the drain, source, and bulk terminals set to 0V or connected to ground. With NAND memory cell strings, each block can be selectively erased, and one or more blocks can be simultaneously erased. When successfully erased, all erased floating gate memory cells 206-207 in a string 210 will have a negative threshold voltage and are effectively set to a first or default logic state (e.g., logic “11”). To program the a selected cell, known programming techniques may also be used, such as applying positive word line pulse (e.g., WL31) to the gate of the selected bitcell (e.g., 206), while the drain, source, and bulk voltages are set to 0V (or grounded). This causes charge to be pushed into the floating gate. In multi-level bit cells, multi-level pulses are required to place the cell in each of its possible states, resulting in a plurality (e.g., four to eight) of possible threshold voltage Nit values, each representing a different logic state (e.g., logic “10”, logic “01” and logic. “00”). To read the value stored at a particular bitcell (e.g., 206) in an MLC NAND string, an address supplied to the bit line driver (e.g., 108) and word line driver (e.g., 104) supplies selection voltages to the word line (e.g., WL31) and bit line (e.g., BUT) for the selected bitcell, in selected embodiments, the selection voltages include a read reference voltage that is applied to the word line gates of a selected sector or set of NVM cells and incrementally increased across a plurality of reference voltages (e.g., VREF1, VREF2, VREF3, VREAD) to sense a bit sequence from the selected NVM cell sector/set. When a change in the bit line voltage is detected, the read reference voltage at the time of the change is detected at a bitcell is used to identify the stored logic state for that bitcell. The term “read reference”, as used herein, refers to either a read reference voltage or to read reference current, depending on implementation. The term “sector,” as used herein, refers to an individually programmable/erasable unit of a memory array. The term “memory location,” as used herein, refers to an individually addressable set of bits of a memory array. A sector includes one or more memory locations.

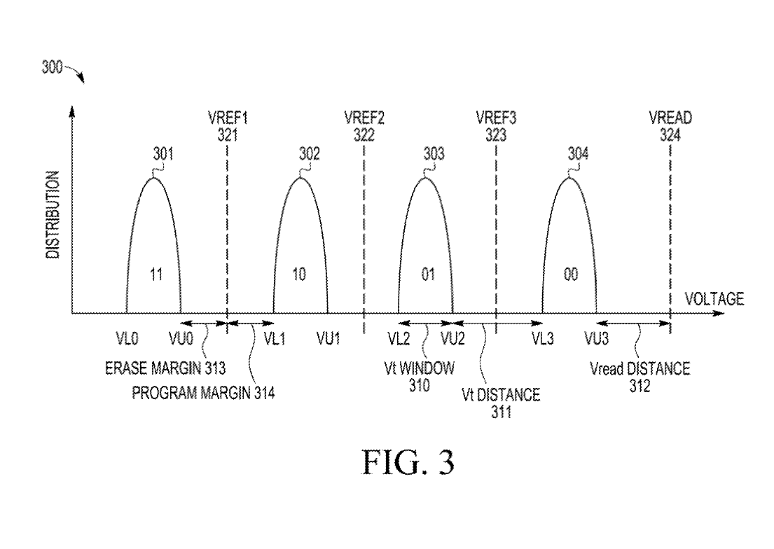

To better understand how a multi-level flash memory bitcell array may be used in accordance with selected embodiments of the present disclosure, reference is now made to FIG. 3 which shows a threshold voltage (Vt) distribution graph 300 for a multi-level flash memory array, where different domain states 301-304 have voltage ranges separated by intermediate reference voltages 321-323. Each domain state depends on how much charge is stored on the bitcell to adjust the cell's reference voltage in relation to a plurality of intermediate reference voltage detection points. In the depicted graph 300, three intermediate reference voltage detection points (VREF1, VREF2, VREF3) are shown, indicating that each multi-level flash memory bitcell is capable of storing four logic states (11, 10, 01, 00) corresponding to two bits of data. To this end, each multi-level flash memory bitcell must store one of four threshold voltage values, depending on the amount of charge stored on the bitcell's floating gate. Of course, the multi-level flash memory bitcells may use additional reference voltage levels to store additional bits (e.g., a three-bit or triple-level cell) to code additional logic states (e.g., 8 states in the case of 3 bit triple-level cell) on the same gate, thereby further increasing the chip storage capacity. For a multi-level flash memory bitcell which store four logic states, a first logic state (e.g., logic “11”) may be programmed or written when all charge is removed from the floating gate, thereby providing at first lowest or negative threshold voltage for the multi-level flash memory bitcell. All erased memory cells will by delimit have this first threshold voltage. The remaining three states may be programmed so that their corresponding threshold voltages will be positive in relation to the first lowest or negative threshold voltage. For example, a first logic state domain 301 (e.g., “11”) is located below as first reference voltage VREF1 (e.g., VREF1=0V), a second logic state domain 302 (e.g., “10”) is located between the first reference voltage VREF1 and a second reference voltage VREF2 (e.g., VREF2=0.25V), a third logic state domain 303 (e.g., “01”) is located between the second reference voltage VREF2 and a third reference voltage VREF3 (e.g., VREF2=0.6V), and a fourth logic state domain 304 (e.g., “00”) is located above the third reference voltage VREF3. In other embodiments, different reference voltage values can be used depending on the available power requirements.

In the illustrated distribution graph 300, the logic state domains are characterized by as plurality of performance parameters which characterize the performance of the multi-level flash memory bitcell array. For example, cell state “11” is between lower and upper limits VL0, VU0; cell state “10” is between lower and upper limits VL1, VU1; cell state “01” is between lower and upper limits VL2, VU2; and cell state “00” is between lower and upper limits VL3, VU3. In addition, each logic state domain (e.g., 303) is characterized by a Vt window parameter 310, while the spread between adjacent logic state domains (e.g., 303, 304) is characterized by a Vt distance parameter 311. There is also a Vread distance parameter 312 which characterizes the distance between the read pass voltage V_{READ} 324 and the upper limit of the fully programmed state (e.g., VU3). As will be appreciated, the placement and setting of these performance parameters in relation to the reference voltage detection points (e.g., VREF1, VREF2, VREF3) are interdependent parameters that determine read/write speed, reliability and lifetime of the multi-level flash memory bitcell array. For optimized performance, a narrow cell Vt window 310 and larger cell Vt distance 311 provides better definition and distinction of logic states. However, with smaller supply voltage ranges and/or increased logic storage states, the cell Vt window 310 is effectively reduced in relation to the cell Vt distance 311, thereby reducing the read sensing margin and eventually leading to a failure to sense neighboring cell states. In such cases, device failure can occur from Vt window overlap with an intermediate reference voltage, or even minimum Vt distance between neighboring cell states. Such overlap can be exacerbated through accumulated program/erase cycles in multi-level flash memories which distort or shift the cell Vt distribution.

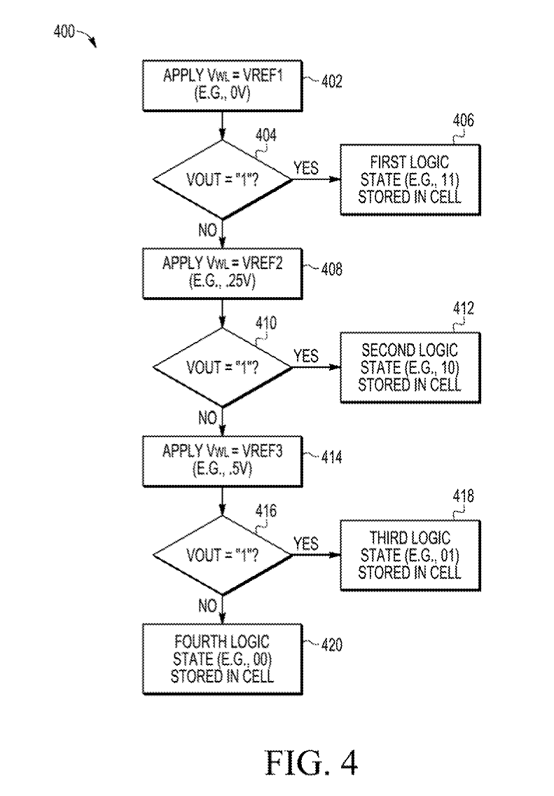

Referring now to FIG. 4, there is shown a simplified flow chart method 400 for reading a multi-level flash memory cell in a flash memory device using one or more adjustable reference voltages in accordance with selected embodiments of the present disclosure. When the read operation starts at an addressed MLC NAND bitcell, a read reference voltage (V_{WL}) having a first reference voltage value (e.g., VREF1=0V) is applied to the word line gate(s) of the addressed MLC NAND bitcell(s) at step 402. At step 404, the associated detection inverter circuit or sense amplifier connected to the associated hit line detects whether the programmed threshold voltage at the addressed MLC NAND bitcell pulls the associated bit line down (e.g., to ground) in response to the first reference voltage value, thereby generating a high output voltage (e.g., VOUT=“1”). If so (as indicated by positive outcome to detection step 404), control logic at the flash memory device determines that the addressed MLC NAND bitcell stores a first logic state (e.g., logic “11”) at step 406. If not (as indicated by negative outcome to detection step 404), the method proceeds to step 408.

At step 408, a read reference voltage (V_{WL}) having a second, larger reference voltage value (e.g., VREF1=0.25V) is applied to the word line gate(s) of the addressed MLC NAND bitcell(s). At step 410, the associated detection inverter circuit/sense amplifier detects whether the programmed threshold voltage at the addressed MLC NAND bitcell pulls the associated bit line down in response to the second reference voltage value, thereby generating a high output voltage (e.g., VOUT=“1”). If so (as indicated by positive outcome to detection step 410), control logic at the flash memory device determines that the addressed MLC NAND bitcell stores a second logic state (e.g., logic “10”) at step 412. If not (as indicated by negative outcome to detection step 410), the method proceeds to step 414.

At step 414, the applied read reference voltage (V_{WL}) is increased to a third reference voltage value (e.g., VREF3=0.5V). At step 416, the associated detection inverter circuit or sense amplifier connected to the associated bit line detects whether the programmed threshold voltage at the addressed MLC NAND bitcell pulls the associated bit line down in response to the third reference voltage value, thereby generating a high output voltage (e.g., VOUT=“1”). If so (as indicated by positive outcome to detection step 416), control logic at the flash memory device determines that the addressed MLC NAND bitcell stores a third logic state (e.g., logic “01”) at step 418. If not (as indicated by negative outcome to detection step 416), control logic at the flash memory device determines that the addressed MLC NAND bitcell stores a fourth logic state (e.g., logic “00”) at step 420.

With tighter spreads between reference voltage levels in multi-level NVM bitcells (as compared to single level cells), reduced or impaired memory cell performance can result. For example, with tighter reference voltage spreads, MLC NAND bitcell performance can rapidly degrade over the course of significant program/erase cycles when read operations are no longer predictable because the stored bitcell values overlap with the reference voltage levels. As the cell voltage shifts to the left over the course of PE cycles, a logic state domain (e.g., 302) that shifts to overlap with a reference voltage detection point (e.g., VREF1) will result in retention errors. In addition, environmental conditions (e.g., reduced operating temperatures) can cause the cell voltage to shift to the right so that a logic state domain (e.g., 303) overlaps with a reference voltage detection point (e.g., VREF3), also resulting in retention errors. Conventional solutions for addressing impaired NAND bitcell performance have been costly and complex, relying on error correction coding, replacement of defective cells with redundant, and other inflexible and complex circuitry which enables the manufacturer (not the user) to adjust performance. In contrast, selected embodiments of the present disclosure provide an efficient and low-cost mechanism for using an externally-provided electrical control code to control and adjust an internal electrical value, thereby enhancing robust operation of the NMV bitcell array. As described herein with reference to the flow chart method shown in FIG. 4 for reading a multi-level flash memory cell in a flash memory device, selected embodiments for adjusting the internal electrical value may be implemented at one or more of the voltage application steps 402, 408, 414 to provide a specific voltage value adjustment (e.g., increase or decrease) to the applied read reference voltage (V_{WL}) in response to specified control codes, such as may be implemented through one or more command set extensions to the ONFI command set. In similar fashion, the applied voltages during other memory operations, such as erase and program operations, can also utilize the approach disclosed herein for providing specific voltage value adjustments using specified control codes, such command set extensions to the ONFI command set.

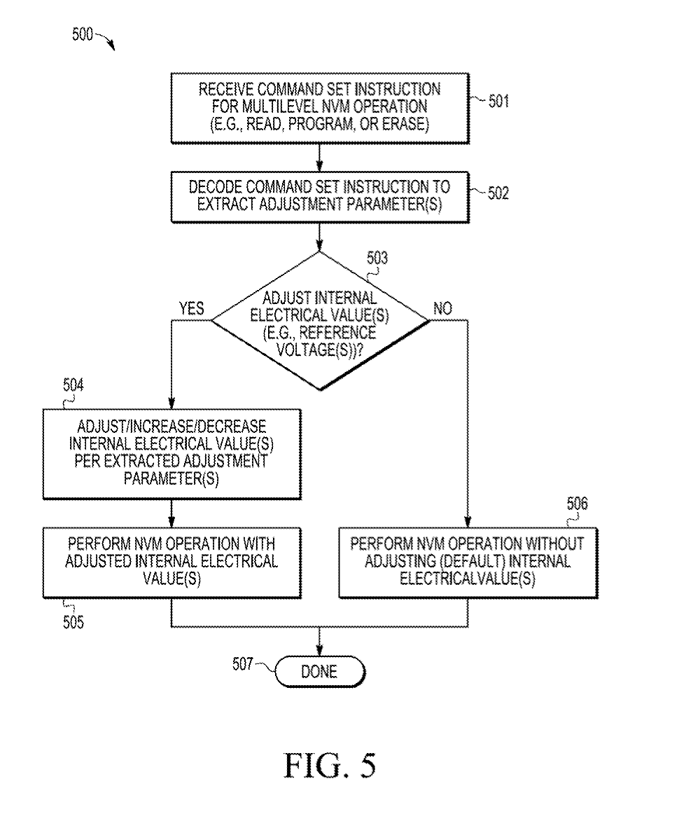

To provide additional example details of selected embodiments of the present disclosure, reference is now made to FIG. 5 which shows a simplified flow chart method 500 for adjusting one or more internal electrical values (e.g., reference voltages) used in the operation of a non-volatile memory device in accordance with selected embodiments of the present disclosure. At step 501, the NVM device receives one or more command set instructions for controlling the operations (e.g., read, program, or erase operations) of a multi-level bitcell array in the NVM device. At step 502, the received command set instructions are decoded to extract one or more adjustment parameters for use during operation of the NVM device. In selected embodiments, the command set instructions may be received as unique instructions which the NVM device is configured to decode and execute. In other embodiments, the command set instructions may be received as defined command set extensions to a standardized NAND Flash device interface (e.g., the ONFI command set) which are decoded and executed by the NVM device to adjust one or more internal reference voltage values used to read, program and/or erase the voltage state stored in a multi-level cell of an accessed NAND string in the NVM device. To the extent that the ONFI interface uses unique opcodes conveyed in two instruction cycles to identify each command, an existing ONFI command (e.g., read) may be extended to provide a plurality of different read commands having different read parameter values by defining unique second cycle opcodes for the read command.

While any internal electrical parameter may be controlled using external codes as described herein, the following table provides an example set of commands and associated parameter values for use in controlling one or more applied read reference voltages (V_{WL}) used during read operations of a MLC NAND bitcell array:

| Command | Applied Internal Electrical Value |
|---|---|
| Read with parameter 00 | Default read threshold voltage(s) (e.g., VREF1, |
| | VREF2, VREF3) with temperature |
| | compensation |
| Read with parameter 01 | Incremented default read threshold voltage(s) |
| | (e.g., +10 mv) with temperature compensation |
| Read with parameter 10 | Decremented default read threshold voltage(s) |
| | (e.g., −10 mv) with temperature compensation |
| Read with parameter 11 | Default read threshold voltage(s) without |
| | temperature compensation |

In similar fashion, specified commands with defined parameter values may be used to control one or more erase margins (EM) defined as the voltage threshold (Vt) difference between a read threshold voltage (e.g., VREF1) and next, lower logic state domain (e.g., VU0 at domain state 301). In FIG. 3, an example erase margin 313 is illustrated. For illustration purposes, the following table provides an example set of commands and associated parameter values for use in individually or collectively controlling the erase margins by adjusting the read threshold voltage value used during erase operations of a MLC NAND bitcell array:

| Command | Applied Internal Electrical Value |
|---|---|
| Erase with parameter 00 | Nominal erase margin using default threshold |
| | voltage(s) (e.g., VREF1, VREF2, VREF3) with |
| | temperature compensation |
| Erase with parameter 01 | Incremented erase margin (e.g., +10 mv with |
| | temperature compensation |
| Erase with parameter 10 | Decremented erase margin (e.g., −10 mv) with |
| | temperature compensation |
| Erase with parameter 11 | Nominal erase margin without temperature |
| | compensation |

As will be appreciated, other internal electrical parameters may be controlled using the command set instructions and associated parameter values. For example, specified commands with defined parameter values may be used to control one or more program margins (PM) defined as the voltage threshold (Vt) difference between a read threshold voltage (e.g., VREF1) and next, higher logic state domain (e.g., VU1 at domain state 302). In FIG. 3, an example program margin 314 is illustrated. For illustration purposes, the following table provides an example set of commands and associated parameter values for individually or collectively controlling one or more the program margins by adjusting the read threshold voltage value used during program operations of a MLC NAND bitcell array:

| Command | Applied Internal Electrical Value |
|---|---|
| Program with parameter 00 | Nominal program margin using default |
| | threshold voltage(s) (e.g., VREF1, VREF2, |
| | VREF3) with temperature compensation |
| Program with parameter 01 | Incremented program margin (e.g., +10 mv) |
| | with temperature compensation |
| Program with parameter 10 | Decremented program margin (e.g., −10 mv) |
| | with temperature compensation |
| Program with parameter 11 | Nominal program margin without |
| | temperature compensation |

While the example commands described hereinabove refer to a default electrical value being incremented or decremented with different commands, it will be appreciated that the adjustment mechanism may instead be configured to adjust the previously used or stored electrical value (as opposed to a default electrical value), thereby enabling more wide ranging adjustments of the device performance.

Referring back to FIG. 5, the decoded command set instructions are then used by the non-volatile memory device to detect whether the identified internal electrical values are to be adjusted at step 503. If the decoded command set instruction indicates that no adjustment is required (negative outcome to detection step 503), then the specified NVM operation is performed at step 506 without adjusting the default (or previously used/stored) internal electrical values. For example, if the decoded command set instruction is for a “read” command with parameter value 11, then the read operation is performed using the default read threshold voltage(s) (e.g., VREF1, VREF2, VREF3) without any temperature compensation. However, if the decoded command set instruction indicates that an adjustment is required (affirmative outcome to detection step 503), then the specified adjustment of the internal electrical parameter is made in accordance with the extracted adjustment parameters at step 504, after which the specified NVM operation is performed at step 505 with the adjusted internal electrical values. For example, if the decoded command set instruction is for a “read” command with parameter value 00, then the read operation is performed using the default read threshold voltage(s) (e.g., VREF1, VREF2, VREF3) with temperature compensation. And if the decoded command set instruction is for a “read” command with parameter value 01, then the read operation is performed with read threshold voltage(s) which are incremented by a set amount (e.g., +10 mv) and adjusted for temperature compensation. Finally, if the decoded command set instruction is for a “read” command with parameter value 10, then the read operation is performed with read threshold voltage(s) which are decremented by a set amount (e.g., −10 mv) and adjusted for temperature compensation. At step 507, the method ends, at which point the non-volatile memory device awaits another command set instruction.

Using externally generated commands or instructions to control the internal electrical values of the non-volatile memory (NVM) device, the strength and safety margins for the NVM device can be improved by adjusting the internal electrical values (e.g., applied reference voltages) to account for changing device performance or conditions. For example, when the domain states of an NVM device drift or shift to lower voltages over the lifecycle of NVM device operation, selected embodiments of the present disclosure provide an external mechanism that may be invoked by the customer in the field to use external commands or instructions to effectively shift intermediate reference voltages by decreasing the applied reference voltages, thereby avoiding retention errors that would otherwise arise. Conversely, when the domain states of an NVM device shift to higher voltages in low temperature environments, selected embodiments of the present disclosure provide an external mechanism for the customer in the field to use external commands or instructions to effectively shift intermediate reference voltages by increasing the applied reference voltages to account for the changed environmental conditions. Similar adjustments to other internal electrical values can be made during other NVM device operations.

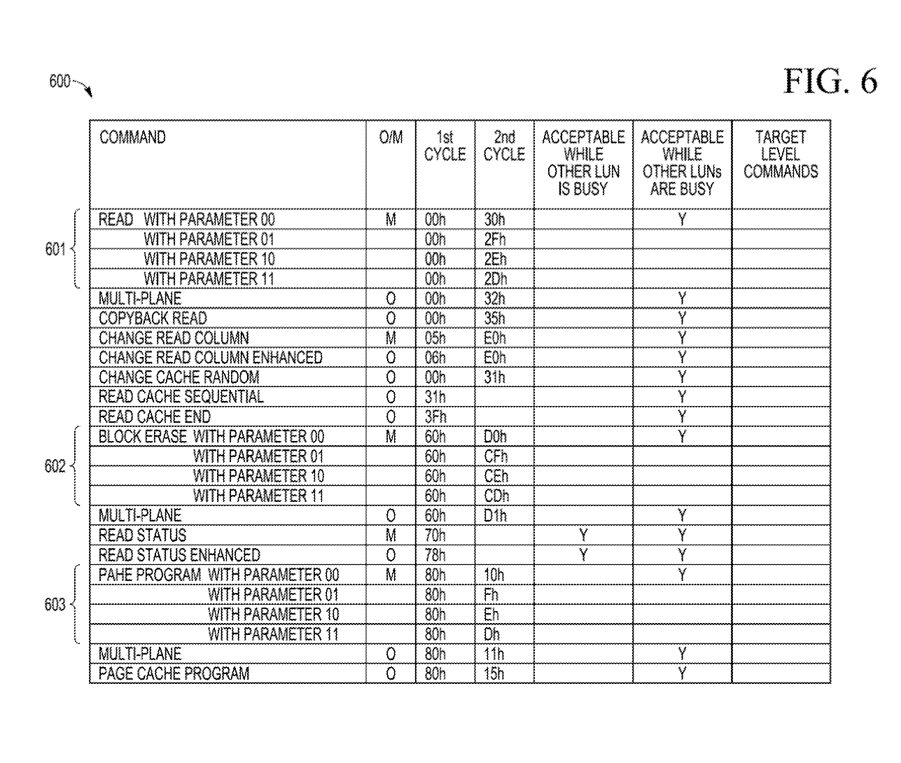

As will be appreciated, the external commands or instructions can have any specified formatting and definition, provided that the NVM device is configured to decode and process the commands/instructions to adjust the internal electrical values. For example, the Open NAND Flash Interface Working Group consortium has developed open standards for NAND flash memory devices, including standard interface specifications for NAND flash chips in which an ONFI command set is specified for controlling NAND flash chip read, write/program, and erase operations. With the ONFI command set, individual commands may be specified with opcodes provided in first and second command cycles, where a first opcode value specified in the first command cycle identifies a command to be performed, alone or in combination with a second opcode value specified in a second command cycle. Within the existing ONFI command set framework, selected embodiments of the present disclosure may be implemented as a command set extension which specifies first and second opcode values to achieve any desired electrical parameter adjustment outcome. To provide an example embodiment of an ONFI command set extension, reference is now made to FIG. 6 which depicts an ONFI command set extension 600 for use in controlling the operation of a NAND Flash device to adjust one or more reference voltages in accordance with selected embodiments of the present disclosure. As depicted, the ONFI command set extension 600 shows a portion of the command set from Table 90 from the Open NAND Flash Interface Specification, Revision 4.0 (Apr. 2, 2014) with modifications to include a plurality of parameterized read instructions 601, erase instructions 602, and program instructions 603.

The parameterized read instructions 601 may be defined with reference to a first set of opcode values (e.g., 1^{st} Cycle=00 h, 2^{nd} Cycle=30 h) to specify a first command with parameter value “00” for performing a read operation using the default read threshold voltage(s) (e.g., VREF1, VREF2, VREF3) with temperature compensation. In this example, the first set of opcode values correspond to the ONFI “Read” command. In addition, the parameterized read instructions 601 may include a second set of opcode values (e.g., 1^{st} Cycle=00 h, 2^{nd} Cycle=2 Fh) to specify a second command with parameter value “01” for performing a read operation in which the default read threshold voltage(s) (e.g., VREF1, VREF2, VREF3) with temperature compensation are incremented by a specified amount (e.g., +10 mV). The parameterized read instructions 601 may also include a third set of opcode values (e.g., 1^{st} Cycle=00 h, 2^{nd} Cycle=2 Eh) to specify a third command with parameter value “10” for performing a read operation in which the default read threshold voltage(s) (e.g., VREF1, VREF2, VREF3) with temperature compensation are decreased by a specified amount (e.g., −10 mV). Finally, the parameterized read instructions 601 may include a fourth set of opcode values (e.g., 1^{st} Cycle=00 h, 2^{nd} Cycle=2 Dh) to specify a fourth command with parameter value “11” for performing a read operation in which the default read threshold voltage(s) (e.g., VREF1, VREF2, VREF3) are applied without temperature compensation. In the example parameterized read instructions 601, the second set of opcode values may use any second cycle hex opcode values which do not conflict with the other ONFI commands.

In similar fashion, the parameterized erase instructions 602 may be defined with reference to a first set of erase opcode values (e.g., 1^{st} Cycle=60 h, 2^{nd} Cycle=D0 h) to specify a first erase command with parameter value “00” for performing an erase operation using the default erase margin with temperature compensation. In this example, the first set of erase opcode values correspond to the ONFI “Block Erase” command. In addition, the parameterized erase instructions 602 may include a second set of erase opcode values (e.g., 1^{st} Cycle=60 h, 2^{nd} Cycle=CFh) to specify a second erase command with parameter value “01” for performing an erase operation in which the erase margin with temperature compensation is incremented by a specified amount (e.g., +10 mV). The parameterized erase instructions 602 may also include a third set of erase opcode values (e.g., 1^{st} Cycle=60 h, 2^{nd} Cycle=CEh) to specify a third erase command with parameter value “10” for performing an erase operation in which erase margin with temperature compensation is decreased by a specified amount (e.g., −10 mV). Finally, the parameterized erase instructions 602 may include a fourth set of erase opcode values (e.g., 1^{st} Cycle=60 h, 2^{nd} Cycle=CDh) to specify a fourth erase command with parameter value “11” for performing an erase operation in which the default erase margin is applied without temperature compensation. Again, the parameterized erase instructions 602 may use any second cycle hex opcode values which do not conflict with the other ONFI commands.

Finally, the parameterized program instructions 603 may be defined with reference to a first set of program opcode values (e.g., 1^{st} Cycle=80 h, 2^{nd} Cycle=10 h) to specify a first program command with parameter value “00” for performing a program operation using the default program margin with temperature compensation. In this example, the first set of program opcode values correspond to the ONFI “Page Program” command. In addition, the parameterized program instructions 603 may include a second set of program opcode values (e.g., 1^{st} Cycle=80 h, 2^{nd} Cycle=Fh) to specify a second program command with parameter value “01” for performing a program operation in which the program margin with temperature compensation is incremented by a specified amount (e.g., +10 mV). The parameterized program instructions 603 may also include a third set of program opcode values (e.g., 1^{st} Cycle=80 h, 2^{nd} Cycle=Eh) to specify a third program command with parameter value “10” for performing a program operation in which program margin with temperature compensation is decreased by a specified amount (e.g., −10 mV). Finally, the parameterized program instructions 603 may include a fourth set of program opcode values (e.g., 1^{st} Cycle=80 h, 2^{nd} Cycle=Dh) to specify a fourth program command with parameter value “11” for performing a program operation in which the default program margin is applied without temperature compensation. Again, the parameterized program instructions 603 may use any second cycle hex opcode values which do not conflict with the other ONFI commands.

By now it should be appreciated that there is provided herein a method and apparatus for operating a non-volatile memory. In the disclosed methodology, a memory access instruction for accessing a non-volatile memory array is received and decoded. Based on an adjustment control parameter conveyed by the memory access instruction, an adjusted internal electrical parameter is generated for accessing the non-volatile memory array, and the non-volatile memory array is accessed using the adjusted internal electrical parameter. The received memory access instruction may be an instruction for accessing a NAND Flash memory which is compliant with an Open NAND Flash Interface (ONFI) protocol, and includes a two command cycle sequence to specify a command for accessing the NAND Flash memory. In selected embodiments, the adjusted internal electrical parameter is generated by increasing or decreasing or applying a temperature compensation adjustment to one or more read reference voltages that are applied to a gate of a multi-level cell (MLC) in the non-volatile memory array during a read operation for accessing the non-volatile memory array, where the predetermined adjustment (e.g., increment, decrement, or temperature compensation) corresponds to the adjustment control parameter conveyed by the memory access instruction. In other embodiments, the adjusted internal electrical parameter is generated by increasing or decreasing or applying a temperature compensation adjustment to an erase margin that is applied to a block of bitcells in the non-volatile memory array during an erase operation for accessing the non-volatile memory array, where the predetermined adjustment (e.g., increment, decrement, or temperature compensation) corresponds to the adjustment control parameter conveyed by the memory access instruction. In yet other embodiments, the adjusted internal electrical parameter is generated by increasing or decreasing or applying a temperature compensation adjustment to a program margin that is applied to a page of bitcells in the non-volatile memory array during a program operation for accessing the non-volatile memory array, where the predetermined adjustment (e.g., increment, decrement, or temperature compensation) corresponds to the adjustment control parameter conveyed by the memory access instruction.

In another form, there is provided herein a non-volatile memory device and associated method of operation for using an ONFI command set extension to control operation of the non-volatile memory device. The disclosed device includes a power supply unit for generating a supply voltage, such as a charge pump circuit for generating an adjustable supply voltage in response to a control signal. The disclosed device also includes a non-volatile memory array with one or more line driver circuits and a plurality of sets of bit cells arranged in rows and columns, with the non-volatile memory array adapted to receive the supply voltage at the one or more line driver circuits. In addition, the disclosed device includes a controller adapted to receive a memory access instruction for accessing the non-volatile memory array, where the instruction includes a control code and where the controller is adapted to provide a control signal to the power supply unit for adjusting the supply voltage generated by the power supply unit based on the control code. In selected embodiments, the memory access instruction is compliant with an Open NAND Flash Interface (ONFI) protocol for accessing a NAND Flash memory. In selected embodiments, the controller provides a control signal to the power supply unit to increase or decrease one or more read reference voltages by a predetermined adjustment amount that are applied to a gate of a multi-level cell (MLC) in the non-volatile memory array during a read operation, where the predetermined adjustment amount (e.g., increment, decrement, or temperature compensation) corresponds to the control code in the memory access instruction. In other embodiments, the controller provides a control signal to the power supply unit to increase or decrease an erase margin that is applied to a block of multi-level bitcells in the non-volatile memory array during an erase operation, where the predetermined adjustment amount (e.g., increment, decrement, or temperature compensation) corresponds to the control code in the memory access instruction. In yet other embodiments, the controller provides a control signal to the power supply unit to increase or decrease the program margin that is applied to a page of multi-level bitcells in the non-volatile memory array during a program operation, where the predetermined adjustment amount (e.g., increment, decrement, or temperature compensation) corresponds to the control code in the memory access instruction.

Various illustrative embodiments of the present invention have been described in detail with reference to the accompanying figures. While various details are set forth in the foregoing description, it will be appreciated that the present invention may be practiced without these specific details, and that numerous implementation-specific decisions may be made to the invention described herein to achieve the device designer's specific goals, such as compliance with process technology or design-related constraints, which will vary from one implementation to another. While such a development effort might be complex and time-consuming, it would nevertheless be a routine undertaking for those of ordinary skill in the art having the benefit of this disclosure. For example, selected aspects are depicted with reference to simplified block diagrams and flow charts illustrating design and operational details of a non-volatile memory device without including every device feature or aspect in order to avoid limiting or obscuring the present invention. Such descriptions and representations are used by those skilled in the art to describe and convey the substance of their work to others skilled in the art, and the omitted details which are well known are not considered necessary to teach one skilled in the art of how to make or use the present invention. Some portions of the detailed descriptions provided herein are also presented in terms of algorithms and instructions that operate on data that is stored in a computer memory. In general, an algorithm refers to a self-consistent sequence of steps leading to a desired result, where a “step” refers to a manipulation of physical quantities which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities. Unless specifically stated otherwise as apparent from the following discussion, it is appreciated that, throughout the description, discussions using terms such as “processing” or “computing” or “calculating” or “determining” or “displaying” or the like, refer to the action and processes of hardware or a computer system or a similar electronic computing device, that manipulates and transforms data represented as physical (electronic) quantities within registers and memories into other data similarly represented as physical quantities within the memories or registers or other such information storage, transmission or display devices.

Although the described exemplary embodiments disclosed herein are directed to various non-volatile memory systems and methods for using control codes to externally control one or more internal electrical parameters used to access the non-volatile memory systems, the present invention is not necessarily limited to the example embodiments which illustrate inventive aspects of the present invention that are applicable to a wide variety of information processing systems and circuits. Thus, the particular embodiments disclosed above are illustrative only and should not be taken as limitations upon the present invention, as the invention may be modified and practiced in different but equivalent manners apparent to those skilled in the art having the benefit of the teachings herein. For example, although FIG. 1 and the discussion thereof describe an exemplary flash memory device architecture, this exemplary architecture is presented merely to provide a useful reference in discussing various aspects of the invention, and is not intended to be limiting so that persons of skill in the art will understand that the principles taught herein apply to other types of devices. For example, selected embodiments may implement the illustrated elements of system 100 on a single integrated circuit or within a single device. Alternatively, system 100 may include any number of separate integrated circuits or separate devices interconnected with each other. In yet other embodiments, the external control codes may be used to control one or more internal electrical parameters in other types of memories or integrated circuit devices that may be considered beneficial. Furthermore, those skilled in the art will recognize that boundaries between the functionality of the above described operations merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments. Accordingly, the foregoing description is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. In addition, the term “coupled,” as used herein, is not intended to be limited to a direct coupling or a mechanical coupling. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements.

What is claimed is:

1. A method comprising:
receiving a memory access instruction for accessing a non-volatile memory array;
generating an adjusted internal electrical parameter for accessing the non-volatile memory array based on an adjustment control parameter conveyed by the memory access instruction, and
accessing the non-volatile memory array using the adjusted internal electrical parameter.

2. The method of claim 1, where receiving the memory access instruction comprises receiving a memory access instruction for accessing a NAND Flash memory which is compliant with an Open NAND Flash Interface (ONFI) protocol, where the memory access instruction comprises a two command cycle sequence to specify a command for accessing the NAND Flash memory.

3. The method of claim 1, where generating the adjusted internal electrical parameter comprises increasing by a predetermined increment one or more read reference voltages that are applied to a gate of a multi-level cell (MLC) in the non-volatile memory array during a read operation for accessing the non-volatile memory array, where the predetermined increment corresponds to the adjustment control parameter conveyed by the memory access instruction.

4. The method of claim 1, where generating the adjusted internal electrical parameter comprises decreasing by a predetermined decrement one or more read reference voltages that are applied to a gate of a multi-level cell (MLC) in the non-volatile memory array during a read operation for accessing the non-volatile memory array, where the predetermined decrement corresponds to the adjustment control parameter conveyed by the memory access instruction.

5. The method of claim 1, where generating the adjusted internal electrical parameter comprises applying a temperature compensation adjustment to one or more read reference voltages that are applied to a gate of a multi-level cell (MLC) in the non-volatile memory array during a read operation for accessing the non-volatile memory array, where the temperature compensation adjustment corresponds to the adjustment control parameter conveyed by the memory access instruction.

6. The method of claim 1, where generating the adjusted internal electrical parameter comprises increasing, by a predetermined increment, an erase margin that is applied to a block of bitcells in the non-volatile memory array during an erase operation for accessing the non-volatile memory array, where the predetermined increment corresponds to the adjustment control parameter conveyed by the memory access instruction.

7. The method of claim 1, where generating the adjusted internal electrical parameter comprises decreasing, by a predetermined decrement, an erase margin that is applied to a block of bitcells in the non-volatile memory array during an erase operation for accessing the non-volatile memory array, where the predetermined decrement corresponds to the adjustment control parameter conveyed by the memory access instruction.

8. The method of claim 1, where generating the adjusted internal electrical parameter comprises applying a temperature compensation adjustment to an erase margin that is applied to a block of bitcells in the non-volatile memory array during an erase operation for accessing the non-volatile memory array, where the temperature compensation adjustment corresponds to the adjustment control parameter conveyed by the memory access instruction.

9. The method of claim 1, where generating the adjusted internal electrical parameter comprises increasing, by a predetermined increment, a program margin that is applied to a page of bitcells in the non-volatile memory array during a program operation for accessing the non-volatile memory array, where the predetermined increment corresponds to the adjustment control parameter conveyed by the memory access instruction.

10. The method of claim 1, where generating the adjusted internal electrical parameter comprises decreasing, by a predetermined decrement, a program margin that is applied to a page of bitcells in the non-volatile memory array during a program operation for accessing the non-volatile memory array, where the predetermined decrement corresponds to the adjustment control parameter conveyed by the memory access instruction.

11. The method of claim 1, where generating the adjusted internal electrical parameter comprises applying a temperature compensation adjustment to a program margin that is applied to a page of bitcells in the non-volatile memory array during a program operation for accessing the non-volatile memory array, where the temperature compensation adjustment corresponds to the adjustment control parameter conveyed by the memory access instruction.

12. A device comprising:
a power supply unit for generating a supply voltage;
a non-volatile memory array comprising one or more line driver circuits and a plurality of sets of bit cells arranged in rows and columns, the non-volatile memory array adapted to receive the supply voltage at the one or more line driver circuits; and
a controller adapted to receive a memory access instruction for accessing the non-volatile memory array which comprises a control code, the controller adapted to provide a control signal to the power supply unit for adjusting the supply voltage generated by the power supply unit based on the control code.

13. The device of claim 12, wherein the power supply unit is a charge pump circuit.

14. The device of claim 12, where the memory access instruction comprises a memory access instruction which is compliant with an Open NAND Flash Interface (ONFI) protocol for accessing a NAND Flash memory.

15. The device of claim 12, where the controller provides a control signal to the power supply unit to increase by a predetermined increment one or more read reference voltages that are applied to a gate of a multi-level cell (MLC) in the non-volatile memory array, where the predetermined increment corresponds to a first control code in the memory access instruction.

16. The device of claim 12, where the controller provides a control signal to the power supply unit to decrease by a predetermined decrement one or more read reference voltages that are applied to a gate of a multi-level cell (MLC) in the non-volatile memory array, where the predetermined decrement corresponds to a second control code in the memory access instruction.

17. The device of claim 12, where the controller provides a control signal to the power supply unit to increase by a predetermined increment an erase margin that is applied to a block of multi-level bitcells in the non-volatile memory array, where the predetermined increment corresponds to a third control code in the memory access instruction.

18. The device of claim 12, where the controller provides a control signal to the power supply unit to decrease by a predetermined decrement an erase margin that is applied to a block of multi-level bitcells in the non-volatile memory array, where the predetermined decrement corresponds to a fourth control code in the memory access instruction.

19. The device of claim 12, where the controller provides a control signal to the power supply unit to increase by a predetermined increment a program margin that is applied to a page of multi-level bitcells in the non-volatile memory array, where the predetermined increment corresponds to a fifth control code in the memory access instruction.

20. The device of claim 12, where the controller provides a control signal to the power supply unit to decrease by a predetermined decrement a program margin that is applied to a page of multi-level bitcells in the non-volatile memory array, where the predetermined decrement corresponds to a sixth control code in the memory access instruction.
